(19) United States
(12) Patent Application Publication
(10) Pub. No.: US 2026/0063948 A1
(43) Pub. Date: Mar. 5, 2026

(54) DISPLAY DEVICE

(71) Applicant: LG Display Co., Ltd., Seoul (KR)

(72) Inventors: Junehwan KIM, Hwaseong-si (KR); Youngmin OH, Yeosu-si (KR)

(73) Assignee: LG Display Co., Ltd., Seoul (KR)

(21) Appl. No.: 19/242,659

(22) Filed: Jun. 18, 2025

(30) Foreign Application Priority Data
Sep. 3, 2024 (KR) 10-2024-0119026

(51) Int. Cl. G02F 1/13357; G02F 1/1335; G02F 1/1343

(52) U.S. Cl. CPC G02F 1/133606; G02F 1/133512; G02F 1/133514; G02F 1/133528; G02F 1/134309

(57) ABSTRACT

A display device includes a display panel including a plurality of color filters and a black matrix between the plurality of color filters, a backlight unit disposed below the display panel, and a light shutter disposed in any one of an area between the backlight unit and the display panel, an inside of the display panel, and an upper portion of the display panel and including a plurality of shutter structures. Each of the plurality of shutter structures includes a dispersion including a first part overlapping the plurality of color filters, a second part extending from the first part, and a third part extending from the second part and overlapping the black matrix, a plurality of black particles dispersed in the dispersion, and a plurality of transparent particles dispersed in the dispersion.

### CROSS-REFERENCE TO RELATED APPLICATION

This application claims the priority of Korean Patent Application No. 10-2024-0119026, filed on Sep. 3, 2024, in the Korean Intellectual Property Office, the disclosure of which is incorporated herein by reference.

### BACKGROUND

### Field

The present disclosure relates to a display device and, more particularly, to a display device including a light shutter.

### Description of the Related Art

A liquid crystal display (LCD) has features, such as light weight, thin thickness, and low power consumption so that an application range of the liquid crystal display is wide. The liquid crystal display displays images by adjusting a transmittance of liquid crystal using an electric field. To this end, the liquid crystal display device may display desired images on a screen by adjusting light transmittance in accordance with liquid crystals arranged in a matrix and an image signal applied to a plurality of control switches. Since the liquid crystal display device is not a self-emitting display device, a backlight unit which supplies light to a rear surface of a display panel is equipped.

In the meantime, liquid crystal alignment and electric field application methods of the liquid crystal display device may be configured in various ways, such as twisted nematic (TN), vertical alignment (VA), and in-plane switching (IPS) methods. Here, the IPS method is a method which places the liquid crystal to be horizontal to the substrate and controls the liquid crystal using a horizontal electric field and has excellent viewing angle characteristic and color quality and is stable for touch input. However, the IPS method has a disadvantage of a low contrast ratio due to the light leakage when expressing black.

### SUMMARY

An object to be achieved by the present disclosure is to provide a display device with an improved black display quality.

Another object to be achieved by the present disclosure is to provide a display device in which light leakage is improved to improve a contrast ratio.

Still another object to be achieved by the present disclosure is to provide a display device in which light passing through a light shutter is collected and emitted to minimize or suppress the luminance degradation due to the light shutter.

Still another object to be achieved by the present disclosure is to provide a display device in which black particles of a shutter structure is not affected by a surrounding control electrode.

Objects of the present disclosure are not limited to the above-mentioned objects, and other objects, which are not mentioned above, can be clearly understood by those skilled in the art from the following descriptions.

According to an aspect of the present disclosure, a display device includes a display panel including a plurality of color filters and a black matrix between the plurality of color filters, a backlight unit disposed below the display panel, and a light shutter disposed in any one of an area between the backlight unit and the display panel, an inside of the display panel, and an upper portion of the display panel and including a plurality of shutter structures. Each of the plurality of shutter structures includes a dispersion including a first part overlapping the plurality of color filters, a second part extending from the first part, and a third part extending from the second part and overlapping the black matrix, a plurality of black particles dispersed in the dispersion, and a plurality of transparent particles dispersed in the dispersion. Accordingly, the light shutter capable of blocking light is used to minimize or reduce light leakage and improve a contrast ratio of the display device.

Other detailed matters of the example embodiments are included in the detailed description and the drawings.

According to an aspect of the present disclosure, light leaked from liquid crystal is blocked by a light shutter to improve a display quality of a black image.

According to an aspect of the present disclosure, the light shutter additionally blocks light to improve a black display quality and improve a contrast ratio.

According to an aspect of the present disclosure, light which passes through the light shutter is collected and emitted to minimize or suppress the luminance degradation due to the light shutter.

According to an aspect of the present disclosure, a plurality of shutter structures is disposed to be spaced apart from each other to easily control a plurality of black particles.

The effects according to the present disclosure are not limited to the contents exemplified above, and more various effects are included in the present specification.

Additional features and aspects of the present disclosure are set forth in the description that follows and in part will become apparent from the description or may be learned by practice of the inventive concepts provided herein. Other features and aspects of the inventive concepts may be realized and attained by the structure particularly pointed out in, or derivable from, the written description, claims hereof, and the appended drawings.

It is to be understood that both the foregoing general description and the following detailed description of the present disclosure are by way of example and are intended to provide further explanation of the disclosures as claimed.

### BRIEF DESCRIPTION OF DRAWINGS

The accompanying drawings, which are included to provide a further understanding of the present disclosure and are incorporated in and constitute a part of this application, illustrate various aspects of the disclosure and together with the description serve to explain various principles of the present disclosure. In the drawings:

FIG. 1 is a schematic diagram of a display device according to an example embodiment of the present disclosure;

FIG. 2 is a schematic cross-sectional view of a display device according to an example embodiment of the present disclosure;

FIG. 3 is an enlarged plan view of a display panel of a display device according to an example embodiment of the present disclosure;

FIG. 4 is a cross-sectional view of a sub pixel of a display device according to an example embodiment of the present disclosure;

FIG. 5 is a cross-sectional view taken along V-V′ in FIG. 3;

FIG. 6 is a cross-sectional view taken along VI-VI′ in FIG. 3;

FIG. 7 is a cross-sectional view for explaining an operation of a light shutter of a display device according to an example embodiment of the present disclosure;

FIG. 8 is a graph of comparing a contrast ratio according to a viewing angle in display devices according to Comparative Example and an example embodiment of a present disclosure (Example);

FIGS. 9A and 9B are cross-sectional views of a display device according to other example embodiments of the present disclosure; and

FIGS. 10A to 10C are schematic cross-sectional views of a display device according to still other example embodiments of the present disclosure.

### DETAILED DESCRIPTION

Advantages and characteristics of the present disclosure and a method of achieving the advantages and characteristics will be clear by referring to example embodiments described below in detail together with the accompanying drawings. However, the present disclosure is not limited to the example embodiments disclosed herein but can be implemented in various other forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as ‘including’, ‘having’, ‘consist of’ used herein are generally intended to allow other components to be added unless the terms are used with a more limiting term like ‘only’. Any references to singular may include plural, and vice versa, unless expressly stated otherwise.

Components are interpreted to include an ordinary error range even if not expressly stated.

Where the position relation between two parts is described using the terms such as ‘on’, ‘above’, ‘below’, ‘next’, one or more parts may be positioned between the two parts unless the terms are used with a more limiting term like ‘immediately’ or ‘directly’.

Where an element or layer is disposed “on” another element or layer, another layer or another element may be interposed directly on the other element or therebetween.

Although the terms “first”, “second”, and the like may be used for describing various components, these components are not confined by these terms. These terms are merely used for referring to one component separately from the other components. Therefore, a first component to be mentioned below may be a second component, and vice versa, in a technical concept of the present disclosure.

Like reference numerals generally denote like elements throughout the specification unless otherwise specified.

A size and a thickness of each component illustrated in the drawing are illustrated for convenience of description, and the present disclosure is not limited to the size and the thickness of the component illustrated.

The features of various example embodiments of the present disclosure can be partially or entirely adhered to or combined with each other and can be interlocked and operated in technically various ways, and the example embodiments can be carried out independently of or in association with each other.

Hereinafter, various example embodiments of the present disclosure will be described in detail with reference to accompanying drawings.

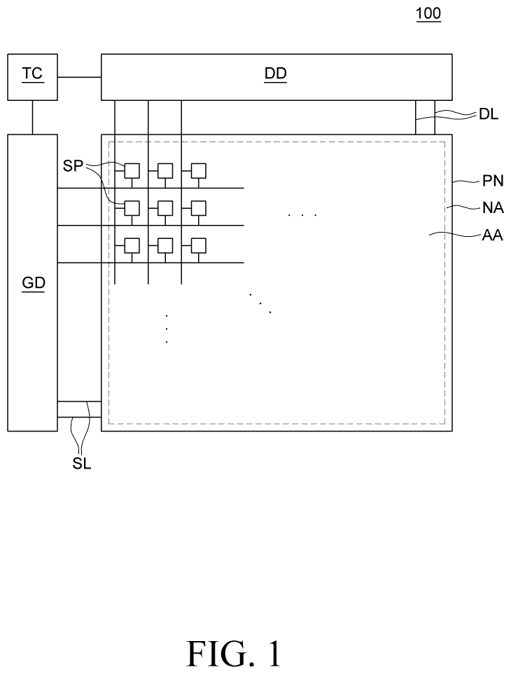

FIG. 1 is a schematic diagram of a display device according to an example embodiment of the present disclosure. In FIG. 1, for the convenience of description, among various components of the display device 100, only a display panel PN, a gate driver GD, a data driver DD, and a timing controller TC are illustrated.

As shown in FIG. 1, the display device 100 includes a display panel PN including a plurality of sub pixels SP, a gate driver GD and a data driver DD which supply various signals to the display panel PN, and a timing controller TC which controls the gate driver GD and the data driver DD.

The gate driver GD supplies a plurality of scan signals to a plurality of scan lines SL according to a plurality of gate control signals supplied from the timing controller TC. Even though in FIG. 1, it is illustrated that one gate driver GD is disposed to be spaced apart from one side of the display panel PN, the number of the gate drivers GD and the placement thereof are not limited thereto.

The data driver DD supplies a data voltage to a plurality of data lines DL according to a plurality of data control signals and image data supplied from the timing controller TC. The data driver DD converts the image data into a data voltage using a reference gamma voltage and supplies the converted data voltage to the plurality of data lines DL.

The timing controller TC aligns image data input from the outside to supply the image data to the data driver DD. The timing controller TC may generate a gate control signal and a data control signal using synchronization signals input from the outside, such as a dot clock signal, a data enable signal, and horizontal/vertical synchronization signals. The timing controller TC supplies the generated gate control signal and data control signal to the gate driver GD and the data driver DD, respectively, to control the gate driver GD and the data driver DD.

The display panel PN is a configuration which displays images to the user and includes the plurality of sub pixels SP. In the display panel PN, the plurality of scan lines SL and the plurality of data lines DL intersect each other, and the plurality of sub pixels SP is formed at intersections of the scan lines SL and the data lines DL.

In the display panel PN, an active area AA and a non-active area NA are defined.

The active area AA is an area in which images are displayed in the display device 100. In the active area AA, a plurality of sub pixels SP which configures a plurality of pixels and a pixel circuit for driving the plurality of sub pixels SP may be disposed. The plurality of sub pixels SP is a minimum unit which configures the active area AA and n sub pixels SP form one pixel. In each of the plurality of sub pixels SP, a plurality of display elements and a thin film transistor for driving the plurality of display elements may be disposed. The plurality of display elements may be defined in different manners depending on the type of the display device 100. For example, when the display device 100 is a liquid crystal display device, the display element may be a liquid crystal. As another example, when the display device 100 is an organic light emitting display device, the display element may be an organic light emitting diode (OLED) and when the display device 100 is an inorganic light emitting device, the light emitting diode may be a light-emitting diode (LED) or a micro light emitting diode (micro LED).

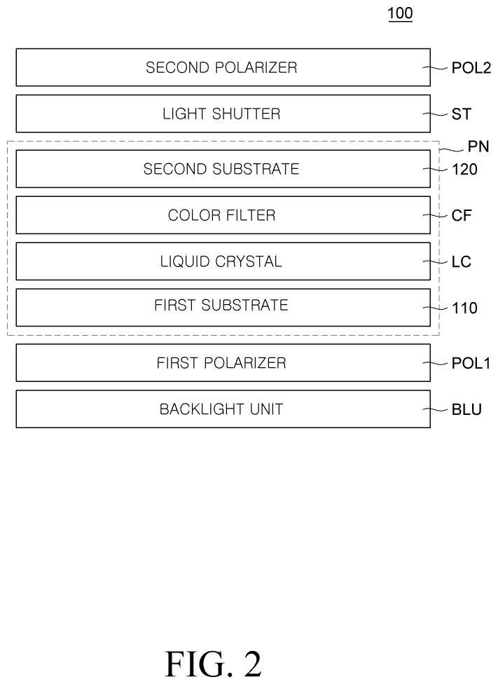

Hereinafter, the description will be made by assuming that the display device 100 according to the example embodiment of the present disclosure is a liquid crystal display device 100 including liquid crystals. When the display device 100 is a liquid crystal display device 100, the display device 100 further includes a backlight unit BLU below the display panel PN and a polarizer on a front surface and a rear surface of the display panel PN to display images using liquid crystals. The display device 100 will be described in more detail with reference to FIGS. 2 to 4.

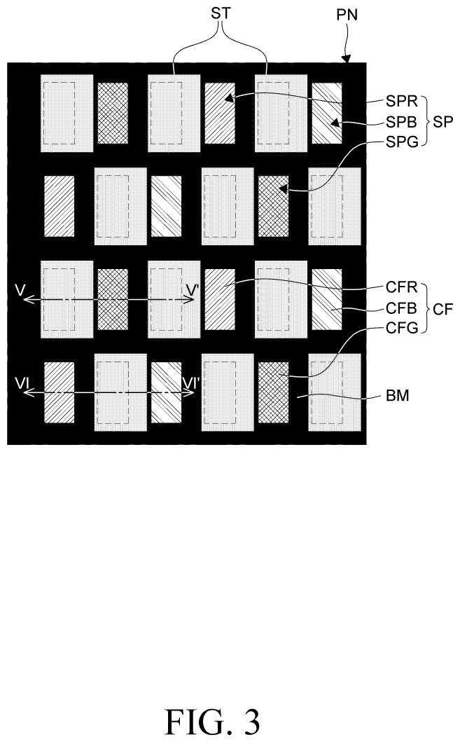

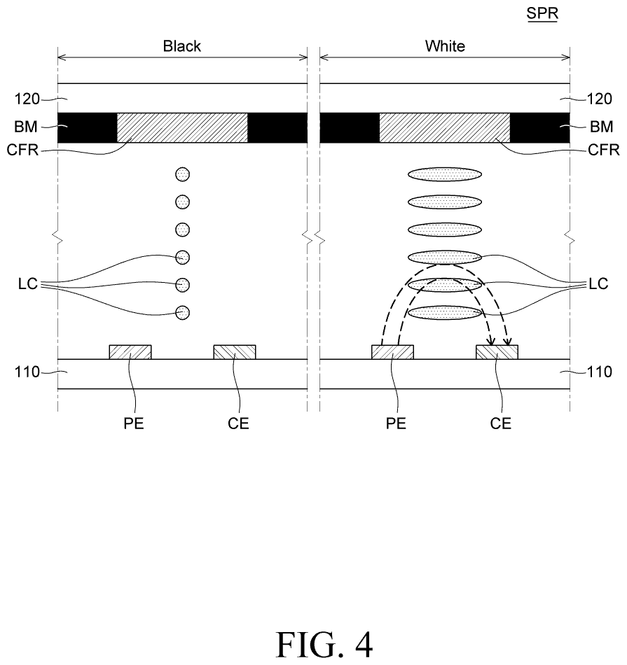

FIG. 2 is a schematic cross-sectional view of a display device according to an example embodiment of the present disclosure. FIG. 3 is an enlarged plan view of a display panel of a display device according to an example embodiment of the present disclosure. FIG. 4 is a cross-sectional view of a sub pixel of a display device according to an example embodiment of the present disclosure. Specifically, FIG. 4 is a cross-sectional view of a red sub pixel SPR of the plurality of sub pixels and even though it is not illustrated in the drawing, the green sub pixel SPG and the blue sub pixel SPB may have the same structure as the red sub pixel SPR.

As shown in FIGS. 2 to 4, the display panel PN includes a first substrate 110, a liquid crystal LC, a color filter CF, and a second substrate 120.

The first substrate 110 and the second substrate 120 are members which support other components of the display panel PN and may be insulating substrates. The first substrate 110 and the second substrate 120 may be bonded with the liquid crystal LC therebetween. For example, the first substrate 110 and the second substrate 120 may be formed of glass or resin.

As shown in FIGS. 2 and 4, the liquid crystal is disposed between the first substrate 110 and the second substrate 120. A plurality of liquid crystal molecules which forms the liquid crystal LC may be disposed in various ways depending on the driving method and rotates by an electric field between a pixel electrode PE and a common electrode CE to adjust a light transmittance. For example, according to the in-plane switching (IPS) method, a plurality of liquid crystal molecules is disposed to be horizontal to one surface of the first substrate 110 and the second substrate 120 and rotates by an electric field between the pixel electrode PE and the common electrode CE. The light transmittance varies according to a rotation angle of the liquid crystal molecules and various images are displayed using this. For example, when the liquid crystals LC is disposed at a specific angle, light from the backlight unit BLU and the first polarizer POL1 is blocked by the liquid crystal LC to display a black image. The liquid crystal LC rotates at various angles in response to an electric field between the pixel electrode PE and the common electrode CE to allow light from the backlight unit BLU and the first polarizer POL1 to travel toward the top of the display panel PN and display a white image.

As shown in FIG. 4, a thin film transistor (TFT) array for driving the liquid crystal LC is disposed on the first substrate 110. The TFT array includes a transistor formed at the intersections of the plurality of scan lines SL and the plurality of data lines DL, a pixel electrode PE to which a data voltage is applied, a common electrode CE to which a common voltage is applied, and a capacitor which maintains a data voltage. For example, in each of the plurality of sub pixels SP, the pixel electrode PE and the common electrode CE of the TFT array are disposed on the same plane and the pixel electrode PE and the common electrode CE form a horizontal electric field.

As shown in FIGS. 2 to 4, the color filter CF is disposed between the second substrate 120 and the liquid crystal LC. The color filter CF converts light which passes through the liquid crystal LC into various color light. For example, when the plurality of sub pixels SP includes a red sub pixel SPR, a green sub pixel SPG, and a blue sub pixel SPB, the color filter CF includes a red color filter CFR, a green color filter CFG, and a blue color filter CFB. However, color filters CF having various colors may be further included depending on a type of the plurality of sub pixels SP and a type of the color filter CF is not limited thereto.

A black matrix BM is disposed between the plurality of color filters CF. The black matrix BM is disposed in a region between the plurality of sub pixels SP. The black matrix BM reduces external light reflection and suppresses color mixture between the plurality of sub pixels SP. The black matrix BM may be formed of an opaque material and for example, may be formed of chrome (Cr), chrome oxide film (Cr2O3), or black resin, but is not limited thereto.

A first polarizer POL1 is disposed below the display panel PN and a second polarizer POL2 is disposed above the display panel PN. The first polarizer POL1 and the second polarizer POL2 are linear polarizers and transmission axes of the first polarizer POL1 and the second polarizer POL2 are configured to be perpendicular to each other. For example, only light which vibrates in a horizontal or vertical direction, among light from the backlight unit BLU passes through the first polarizer POL1 and only light which vibrates in a vertical or horizontal direction, among light from the display panel PN passes through the second polarizer POL2.

The backlight unit BLU is disposed below the display panel PN and the second polarizer POL2. The backlight unit BLU is a configuration which supplies light to the display panel PN. The display panel PN including the liquid crystal CL does not emit light by itself so that the backlight unit BLU which supplies the light is separately provided to display images. The backlight unit BLU includes a plurality of light sources to supply light to the display panel PN. For example, the backlight unit BLU is formed in a direct light type in which the plurality of light sources is disposed below the display panel and an edge light type in which a plurality of light sources is disposed on a side portion of a light guide plate.

The light shutter ST is disposed on the display panel PN. The light shutter ST is a configuration which selectively transmits or blocks light from the display panel PN and minimizes or reduces a light leakage of the display panel PN and improves a contrast ratio. The contrast ratio is a value representing a difference between a minimum luminance and a maximum luminance of the display device 100 so that as the contrast ratio is higher, the difference between darkness and brightness is clearly represented and the display quality is improved. However, in the IPS method, when the black image is displayed, a part of light is leaked in a diagonal direction of the liquid crystal (LC) so that the black display quality is low and the contrast ratio is degraded. Therefore, when the black image is displayed, the light shutter ST is configured to block the light to improve the contrast ratio of the display device 100.

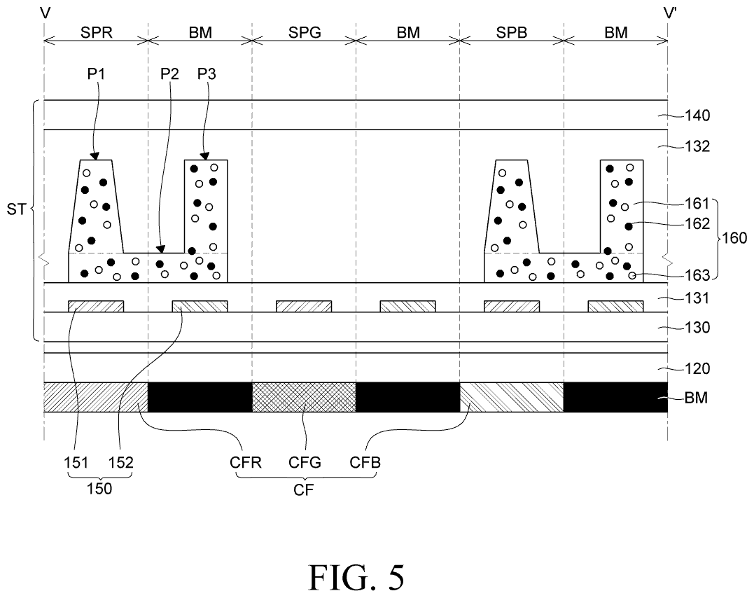

Hereinafter, the light shutter ST will be described with reference to FIGS. 5 to 8 together.

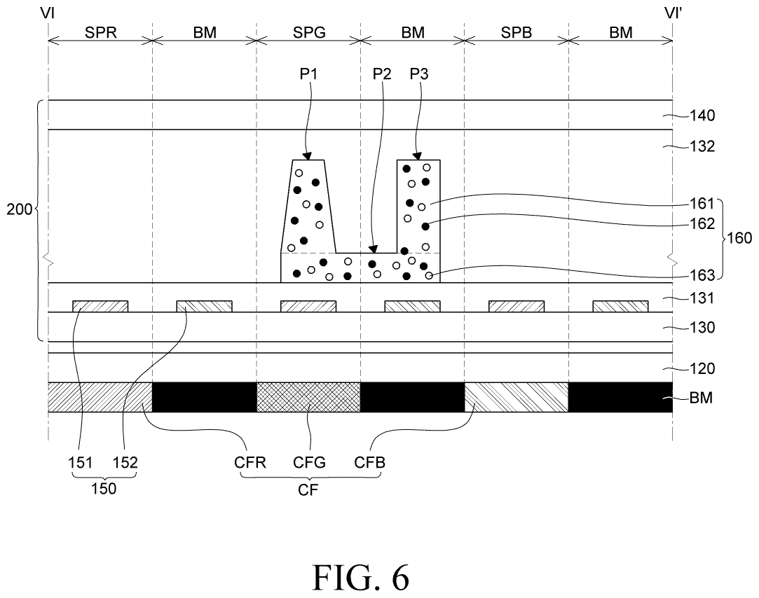

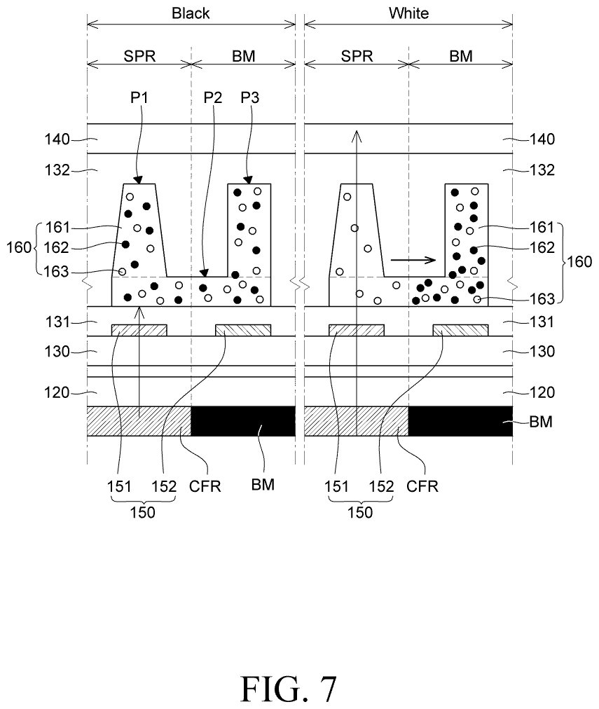

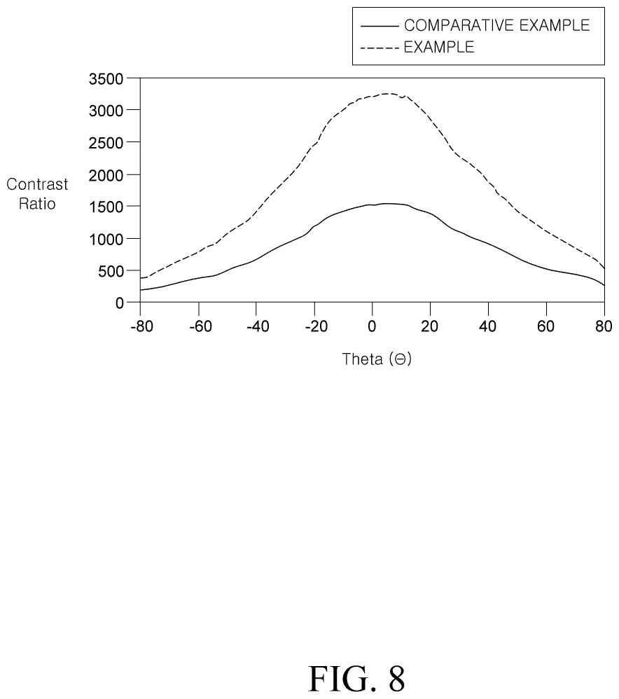

FIG. 5 is a cross-sectional view taken along the line V-V′ of FIG. 3. FIG. 6 is a cross-sectional view taken along the line VI-VI′ of FIG. 3. FIG. 7 is a cross-sectional view for explaining an operation of a light shutter of a display device according to an example embodiment of the present disclosure. FIG. 8 is a graph of comparing a contrast ratio according to a viewing angle in display devices according to Comparative Example and Example. A display device according to Example is a display device 100 according to the example embodiment of the present disclosure, and a display device according to Comparative Example is a display device which does not include a light shutter ST as compared with the display device according to the example embodiment. FIGS. 5 to 7 illustrate only a color filter CF, a black matrix BM, a second substrate 120, and a light shutter ST of a display panel PN for the convenience of description.

As shown in FIGS. 3, 5, and 6, the light shutter ST is disposed on the display panel PN. The light shutter ST includes a lower substrate 130, an adhesive layer 131, a filling layer 132, an upper substrate 140, a plurality of control electrodes 150, and a plurality of shutter structures 160.

First, the lower substrate 130 and the upper substrate 140 of the light shutter ST are members which support other components of the light shutter ST and may be insulating substrates. The lower substrate 130 and the upper substrate 140 are formed of a transparent insulating material, and for example, may be films formed of a material, such as polyethylene terephthalate (PET), triacetyl cellulose (TAC), polyethylene (PE), acryl, or polyolefin, but are not limited thereto.

The plurality of control electrodes 150 is disposed on the lower substrate 130 of the light shutter ST. The plurality of control electrodes 150 includes a first control electrode 151 and a second control electrode 152. The first control electrode 151 is disposed so as to overlap the plurality of sub pixels SP and the plurality of color filters CF and the second control electrode 152 is disposed so as to overlap the black matrix BM. The first control electrode 151 and the second control electrode 152 are electrodes which control black particles 162 of the shutter structure 160 and move the black particles 162 in one direction by an electric field between the first control electrode 151 and the second control electrode 152.

The adhesive layer 131 is disposed on the plurality of control electrodes 150. When the light shutter ST is manufactured, the lower substrate 130 on which the plurality of control electrodes 150 is formed and the upper substrate 140 on which the plurality of shutter structures 160 and the filling layer 132 are formed are bonded to manufacture the light shutter ST. At this time, the adhesive layer 131 is formed on the lower substrate 130 and the plurality of control electrodes 150 to bond the lower substrate 130 and the upper substrate 140. For example, the adhesive layer 131 may include an acrylic resin, but is not limited thereto.

The plurality of shutter structures 160 is disposed on the adhesive layer 131. The plurality of shutter structures 160 is configurations which block or transmit light using the black particles 162. The plurality of shutter structures 160 includes a dispersion 161, a plurality of black particles 162, and a plurality of transparent particles 163.

First, the dispersion 161 is a fluid in which the plurality of black particles 162 and the plurality of transparent particles 163 are dispersed. The dispersion 161 is formed of a transparent material and has a low viscosity characteristic to easily move the plurality of black particles 162. The dispersion 161 includes a first part P1, a second part P2, and a third part P3. For example, the dispersion 161 includes a solvent such as halocarbon oil, paraffin oil, and isopropyl alcohol, and may have a low viscosity characteristic of approximately 50 cps or lower.

The first part P1 of the dispersion 161 is a part which overlaps the plurality of sub pixels SP and the plurality of color filters CF. When the black image is displayed, the plurality of black particles 162 is dispersed in the first part P1 to block the light. When an image other than the black image is displayed, the black particles 162 located in the first part P1 moves to the third part P3 so that the light is emitted to the outside of the display device 100 through the first part P1. At this time, to suppress degradation of the transmittance due to the plurality of black particles 162, a shape of the first part P1 is formed to have a shape advantageous to collect the light to improve the light extraction efficiency. The first part P1 is formed to have a shape which becomes narrower in a width from the bottom to the top so that light incident to the first part P1 from the lower substrate 130 is easily collected. For example, the first part P1 is formed in a trapezoidal shape and a width of a bottom surface of the first part P1 is approximately five times larger than a width of a top surface, but is not limited thereto.

If the first part P1 is formed to have a rectangular shape, like the third part P3, the light collection efficiency is low so that the luminance of the display device is totally degraded. Accordingly, the first part P1 is formed to have a structure which collects light to improve the transmittance of the light shutter ST in a transmission mode.

The second part P2 of the dispersion 161 is a passage which connects the first part P1 and the third part P3 so that the plurality of black particles 162 moves from the first part P1 to the third part P3 or moves from the third part P3 to the first part P1, through the second part P2. The first part P1 is disposed on one end of the second part P2 and the third part P3 is disposed on the other end of the second part P2. The second part P2 is disposed at the border of the plurality of sub pixels SP and the black matrix BM.

The third part P3 of the dispersion 161 overlaps the black matrix BM. When images other than the black image are displayed, the black particles 162 located in the first part P1 move to the third part P3 to be accommodated in the third part P3. Accordingly, when the images other than the black image are displayed, the third part P3 serves as a storage unit which accommodates the black particles 162. At this time, the third part P3 performs only a function of accommodating the black particles 162 so that the third part may be formed in various shapes. For example, as illustrated in the drawing, the third part P3 may be formed in a rectangular shape or other shapes, such as a trapezoidal shape, a circular shape, or a triangular shape, but is not limited thereto.

The plurality of black particles 162 is dispersed in the dispersion 161. The plurality of black particles 162 is charged to move along the electric field of the plurality of control electrodes 150. When the black image is displayed, light from the display panel PN is blocked by the black particles 162 dispersed in the dispersion 161. In contrast, when images other than the black image are displayed, the plurality of black particles 162 moves toward the third part P3. For example, the plurality of black particles 162 is formed of a black material, such as carbon black or black titanium dioxide, and has a diameter of approximately 100 nm or lower, but is not limited thereto.

The plurality of transparent particles 163 is dispersed in the dispersion 161. When images other than the black image are displayed, the plurality of transparent particles 163 is a configuration which improves the light extraction efficiency of light incident to the shutter structure 160. As described above, to suppress the degradation of the transmittance by the plurality of black particles 162, the shape of the first part P1 of the dispersion 161 may be formed to have a structure advantageous to collect light. The extraction efficiency of light collected by the first part P1 is improved using the refractive index difference between the plurality of transparent particles 163 and the filling layer 132. For example, the plurality of transparent particles 163 is formed of silicon oxide (SiO2) particles, hollow silicon oxide (SiO2) particles, or tetraethoxysilane particles TEOS, and has a diameter of approximately 100 nm, but is not limited thereto. Further, the plurality of transparent particles 163 is formed of a material having a refractive index of approximately 1.3 or lower.

A ratio of the plurality of transparent particles 163 disposed in the dispersion 161 is higher than a ratio of the plurality of black particles 162. For example, when the ratio of the plurality of transparent particles 163 and the plurality of black particles 162 is approximately 8:2 or 7:3, the high contrast ratio may be obtained while minimizing or suppressing the degradation of the transmittance.

The filling layer 132 is disposed on the plurality of shutter structures 160 and the adhesive layer 131. The filling layer 132 is disposed so as to cover the plurality of shutter structures 160. The filling layer 132 is formed of a high refractive transparent material to improve the light collection effect of the first part P1 of the shutter structure 160. For example, the filling layer 132 is formed of resin having a refractive index of approximately 1.7 or higher.

The plurality of transparent particles 163 is configured with a low refractive material and the filling layer 132 is configured with a high refractive material to improve the extraction efficiency of a plurality of light. Some light which is directed to the plurality of transparent particles 163 from the filling layer 132 is totally reflected due to the difference of refractive indices between the plurality of transparent particles 163 and the filling layer 132 so that a light path is changed and light which is directed to a front direction is increased. Accordingly, the refractive indices of the filling layer 132 and the plurality of transparent particles 163 are configured to be different to change the path of the plurality of light to the front direction and improve the light extraction efficiency.

In the meantime, as shown in FIGS. 3, 5, and 6, the plurality of shutter structures 160 is disposed so as to overlap only some sub pixel SP, among the plurality of sub pixels SP. The plurality of shutter structures 160 are disposed in a row direction and a column direction to be spaced apart from each other. For example, the plurality of sub pixels SP is disposed in a matrix while forming a plurality of rows and a plurality of columns and the red sub pixel SPR, the green sub pixel SPG, and the blue sub pixel SPB are repeatedly disposed in this order in each of the rows. A shutter structure 160 disposed in an n-th row, among the plurality of rows, is disposed so as to overlap only an odd-numbered sub pixel SP and a shutter structure 160 disposed in a n+1-th row is disposed so as to overlap only an even-numbered sub pixel SP. That is, the plurality of shutter structures 160 is disposed to be spaced apart from each other with an area of one sub pixel SP therebetween and is disposed in a lattice. Therefore, the shutter structure 160 is disposed on only some sub pixel SP and the shutter structure 160 is not disposed on the remaining sub pixel SP.

If the shutter structure 160 is disposed in all the plurality of sub pixels SP, it may be difficult to move the black particles 160 to the third part P3 due to the interference of the electric field between the first control electrode 151 and the second control electrode 152 which are adjacent to each other. For example, a second control electrode 152 which controls the shutter structure 160 on the red sub pixel SPR and a first control electrode 151 which controls the shutter structure 160 on the green sub pixel SPG are disposed to be adjacent to each other. When the plurality of control electrodes 150 is simultaneously driven, an electric field is also formed between the second control electrode 152 which controls the shutter structure 160 on the red sub pixel SPR and the first control electrode 151 which controls the shutter structure 160 on the green sub pixel SPG. Therefore, the black particles 162 in the shutter structure 160 on the green sub pixel SPG may not move to the third part P3. Accordingly, the plurality of shutter structures 150 is disposed to be spaced apart from each other to suppress the movement defect of the black particles 162 due to the interference between the plurality of control electrodes 150.

As shown in FIG. 7, the light shutter ST may be driven in any one of a light-shielding mode (Black) and a transmissive mode (White). For example, when the black image is displayed, the light shutter ST is driven in the light shielding mode (Black) to block the light. When images other than the black image are displayed, the light shutter ST is driven in the transmissive mode (White) to allow the light to pass through the light shutter ST.

In the light shielding mode (Black), the voltage is not applied to the plurality of control electrodes 150 and the plurality of black particles 162 may not move to a specific direction. Therefore, the plurality of black particles 162 may be uniformly dispersed in the first part P1, the second part P2, and the third part P3 of the dispersion 161 and light incident to the light shutter ST is not directed to the outside due to the plurality of black particles 162 and is blocked.

In the transmissive mode (White), the voltage is applied to the plurality of control electrodes 150 to move the plurality of black particles 162 to the third part P3. The black particles 162 located in the first part P1 moves to the third part P3 by the electric field between the plurality of control electrodes 150. Accordingly, the light incident to the light shutter ST is extracted to the outside of the display device 100 through the first part P1 and various images are displayed on the display device 100.

As shown in FIG. 8, it is confirmed that the contrast ratio is improved by the light shutter ST. As described above, the display device according to Example is the display device 100 is the display device 100 according to the example embodiment of the present disclosure illustrated in FIGS. 1 to 7 and a display device according to Comparative Example is a display device which does not include only the light shutter ST, as compared with the display device 100 according to the example embodiment of the present disclosure. As result of measuring the contrast ration according to the viewing angle, it is confirmed that the contrast ratio of the display device according to Example is improved more than the display device according to Comparative Example. Specifically, as it seen from the front surface, in an area of an angle of 0 degree, the difference in the contrast ratio between Comparative Example and Example may be approximately two times or more. Therefore, in the display device 100 according to the example embodiment of the present disclosure, light is blocked from the black image using the light shutter ST to improve a black display quality and improve a contrast ratio.

Accordingly, in the display device 100 according to the example embodiment of the present disclosure, the plurality of shutter structures 160 which overlaps some of the plurality of sub pixels SP is formed to block light leaked from the plurality of sub pixels SP and improve the black display quality. For example, when the black image is displayed, light is not completely blocked in the liquid crystal LC and the light leakage occurs. In this case, the shutter structure 160 of the light shutter ST is driven in the light shielding mode (Black) to block light and improve the display quality of the black image, thereby improving the contrast ratio. Further, when a normal image is displayed, the shutter structure 160 is driven in the transmissive mode (White) to normally extract light from the plurality of sub pixels SP to the outside of the display device 100. Accordingly, the shutter structure 160 which selectively blocks and transmits light is disposed to improve the contrast ratio of the display device 100.

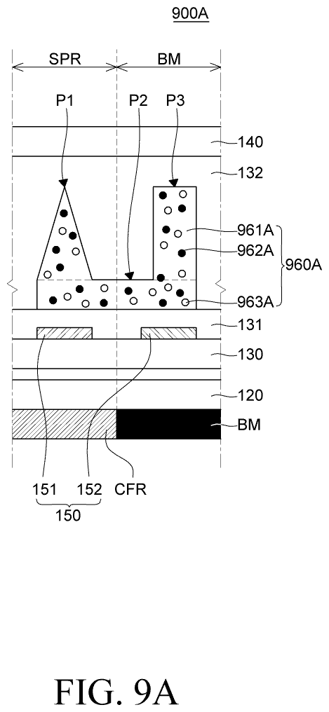

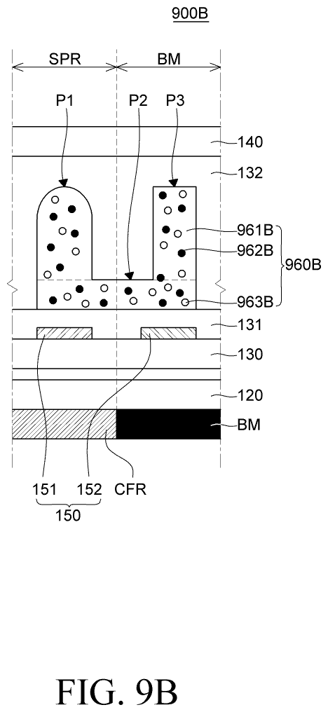

FIGS. 9A and 9B are cross-sectional views of a display device according to another example embodiments of the present disclosure. In FIGS. 9A and 9B, only a color filter CF, a black matrix BM, a second substrate 120, and a light shutter ST of a display panel PN are illustrated for the convenience of description. The only difference between display devices 900A and 900B of FIGS. 9A and 9B and the display device 100 of FIGS. 1 to 7 is shapes of shutter structures 960A and 960B of the light shutter ST, but other configurations are substantially the same, so that a redundant description may be omitted.

As shown in FIGS. 9A and 9B, the shutter structures 960A and 960B of the light shutter ST have a first part P1 which overlaps the plurality of pixels SP and is formed with various shapes of light collection structures. The first part P1 has a shape which becomes narrower from a lower end to an upper end to collect light incident to the first part P1 to be emitted to the outside of the display devices 900A and 900B.

For example, as shown in FIG. 9A, the shutter structure 960A includes a dispersion 961A, black particles 962A, and transparent particles 963A and the first part P1 of the dispersion 961A is formed in a triangular shape. For example, as shown in FIG. 9B, the shutter structure 960B includes a dispersion 961B, black particles 962B, and transparent particles 963B and the first part P1 of the dispersion 961B is formed in a convex lens shape.

Accordingly, in the display devices 900A and 900B according to another example embodiments of the present disclosure, the first part P1 of the shutter structures 960A and 960B is formed to have a structure which becomes narrower from the lower end to the upper end to improve the light extraction efficiency. For example, the first parts P1 of the shutter structures 960A and 960B are formed to have a structure which becomes narrower from the lower end to the upper end, such as a trapezoidal shape, a triangular shape, and a convex lens shape to collect light incident to the light shutter ST. Accordingly, the light is collected in the shutter structures 960A and 960B to be emitted to the outside of the display devices 900A and 900B to improve the light extraction efficiency and the luminance of the display devices 900A and 900B.

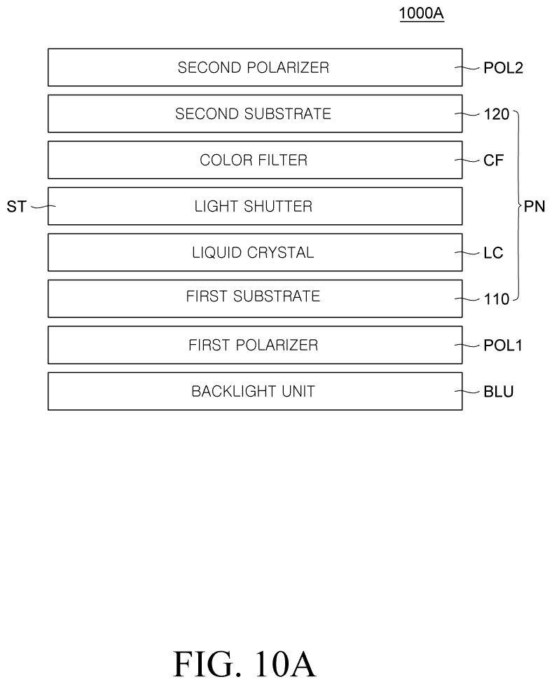

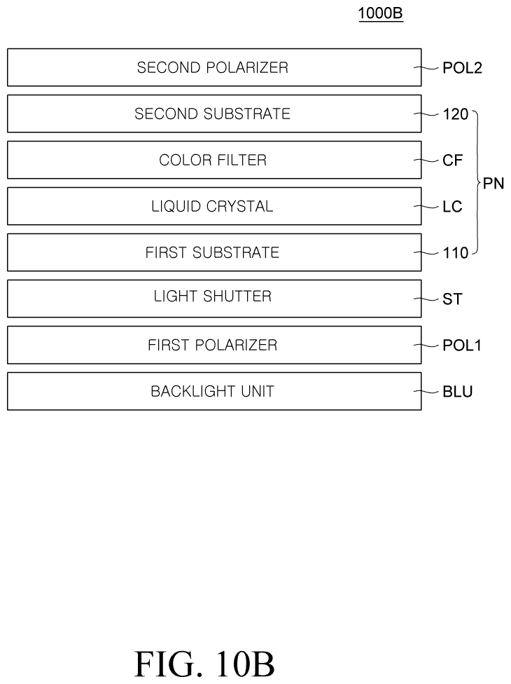

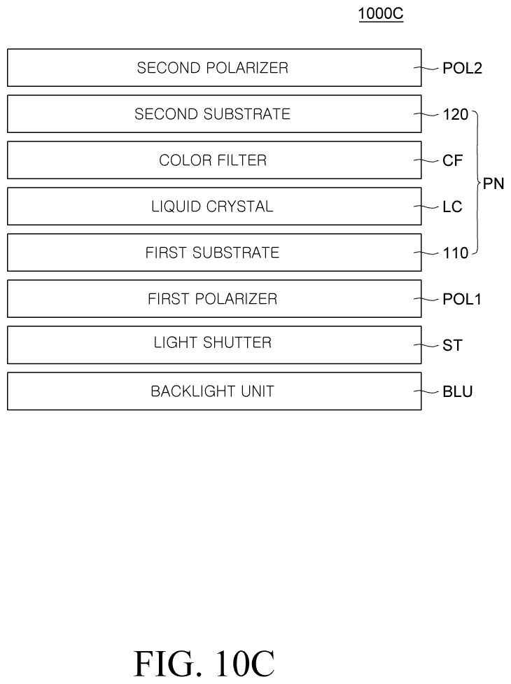

FIGS. 10A to 10C are schematic cross-sectional views of a display device according to still another example embodiments of the present disclosure. The only difference between display devices 1000A, 1000B, and 1000C of FIGS. 10A to 10C and the display device 100 of FIGS. 1 to 7 and the display devices 900A and 900B of FIGS. 9A and 9B is a position of a light shutter ST, but other configurations are substantially the same, so that a redundant description may be omitted.

As shown in FIGS. 10A to 10C, the light shutter ST is disposed on any one of an inside of the display panel PN, a top or a bottom of the display panel PN. The light shutter ST is disposed in any one of areas between the backlight unit BLU and a second polarizer POL2.

In a display device 1000A of FIG. 10A, the light shutter ST is disposed in the display panel PN. For example, the light shutter ST is disposed between the liquid crystal LC and the color filter CF. The light shutter ST controls light which is directed to the color filter CF from the liquid crystal LC.

In the display device 1000B of FIG. 10B, the light shutter ST is disposed below the display panel PN, that is, between the display panel PN and the backlight unit BLU. For example, the light shutter ST is disposed between the first polarizer POL1 and the first substrate 110 of the display panel PN. The light shutter ST controls light which passes through the first polarizer POL1 to be directed to the display panel PN.

In the display device 1000C of FIG. 10C, the light shutter ST is disposed below the display panel PN, that is, between the display panel PN and the backlight unit BLU. For example, the light shutter ST is disposed between the backlight unit BLU and the first polarizer POL1. The light shutter ST controls light which is directed to the first polarizer POL1 from the backlight unit BLU.

Accordingly, in the display devices 1000A, 1000B, and 1000C according to various example embodiments of the present disclosure, the light shutter ST is disposed in any one of areas between the display panel PN and the backlight unit BLU, inside the display panel, and between the display panel PN and the second polarizer POL2 to selectively block the light. Specifically, when the black image is displayed, light from at least some of the plurality of sub pixels SP is blocked to improve the black display quality and the contrast ratio.

The example embodiments of the present disclosure can also be described as follows:

According to an aspect of the present disclosure, a display device includes a display panel which includes a plurality of color filters and a black matrix between the plurality of color filters, a backlight unit disposed below the display panel, and a light shutter which is disposed in any one of an area between the backlight unit and the display panel, an inside of the display panel, and an upper portion of the display panel and includes a plurality of shutter structures. Each of the plurality of shutter structures includes a dispersion including a first part which overlaps the plurality of color filters, a second part extending from the first part, and a third part which extends from the second part and overlaps the black matrix, a plurality of black particles dispersed in the dispersion, and a plurality of transparent particles dispersed in the dispersion. Accordingly, the light shutter which blocks light is used to minimize or reduce light leakage and improve a contrast of the display device.

The first part may become narrower from a lower end to an upper end.

The first part may be formed in any one of a trapezoidal shape, a triangular shape, and a convex lens shape.

The first part may be disposed on one end of the second part and the third part may be disposed on the other end of the second part.

The light shutter may further include a lower substrate disposed below the plurality of shutter structures; a first control electrode disposed between the lower substrate and the first part; and a second control electrode disposed between the lower substrate and the third part.

The plurality of black particles may be configured to move to one direction by an electric field between the first control electrode and the second control electrode.

The light shutter may be driven in any one of a light shielding mode and a transmissive mode. In the light shielding mode, the plurality of black particles and the plurality of transparent particles may be dispersed in the first part, the second part, and the third part.

The plurality of black particles may be configured to block light which is incident to the first part, the second part, and the third part.

In the transmissive mode, the plurality of transparent particles may be dispersed in the first part, the second part, and the third part and the plurality of black particles may be configured to move to the third part by an electric field between the first control electrode and the second control electrode.

At least some of light which is incident to the light shutter may pass through the first part.

The light shutter may further include a filling layer which is disposed on the lower substrate and is disposed so as to enclose the plurality of shutter structures.

A refractive index of the filling layer may be higher than a refractive index of the plurality of transparent particles.

The plurality of color filters may be disposed to form a plurality of columns and a plurality of rows, and the plurality of shutter structures may be disposed so as to overlap some of the plurality of color filters.

Each of the plurality of shutter structures may be disposed to be spaced apart from each other with an area of one color filter, among the plurality of color filters, therebetween.

The display device may further comprise a first polarizer disposed between the display panel and the backlight unit; and a second polarizer disposed on the display panel.

The display panel may further include a first substrate; liquid crystal disposed between the first substrate and the plurality of color filters and between the first substrate and the black matrix; and a second substrate on the plurality of color filters and the black matrix.

The light shutter may be disposed between the second substrate and the second polarizer.

The light shutter may be disposed between the liquid crystal and the plurality of color filters and between the liquid crystal and the black matrix.

The light shutter may be disposed between the first substrate and the first polarizer.

The light shutter may be disposed between the first polarizer and the backlight unit.

Although the example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only and are not intended to limit the technical concept of the present disclosure. The scope of the technical concept of the present disclosure is not limited thereto. Therefore, it should be understood that the above-described example embodiments are illustrative in all aspects and do not limit the present disclosure. The protective scope of the present disclosure should be construed based on the following claims and their equivalents, and all the technical concepts in the equivalent scope thereof should be construed as falling within the scope of the present disclosure.

What is claimed is:

1. A display device, comprising:
a display panel including a plurality of color filters and a black matrix between the plurality of color filters;
a backlight unit disposed below the display panel; and
a light shutter disposed in any one of an area between the backlight unit and the display panel, an inside of the display panel, and an upper portion of the display panel, the light shutter including a plurality of shutter structures,
wherein each of the plurality of shutter structures includes:
a dispersion including a first part overlapping the plurality of color filters, a second part extending from the first part, and a third part extending from the second part and overlapping the black matrix;
a plurality of black particles dispersed in the dispersion; and
a plurality of transparent particles dispersed in the dispersion.

2. The display device of claim 1, wherein the first part becomes narrower from a lower end to an upper end.

3. The display device of claim 2, wherein the first part is formed in any one of a trapezoidal shape, a triangular shape, and a convex lens shape.

4. The display device of claim 1, wherein the first part is disposed on one end of the second part, and the third part is disposed on the other end of the second part.

5. The display device of claim 1, wherein the light shutter further includes:
a lower substrate disposed below the plurality of shutter structures;
a first control electrode disposed between the lower substrate and the first part; and
a second control electrode disposed between the lower substrate and the third part, and
wherein the plurality of black particles are configured to move to one direction by an electric field between the first control electrode and the second control electrode.

6. The display device of claim 5, wherein:
the light shutter is driven in any one of a light shielding mode and a transmissive mode;
in the light shielding mode, the plurality of black particles and the plurality of transparent particles are dispersed in the first part, the second part, and the third part; and
the plurality of black particles are configured to block light which is incident to the first part, the second part, and the third part.

7. The display device of claim 6, wherein:
in the transmissive mode, the plurality of transparent particles are dispersed in the first part, the second part, and the third part, and the plurality of black particles are configured to move to the third part by an electric field between the first control electrode and the second control electrode; and
at least some of light which is incident to the light shutter passes through the first part.

8. The display device of claim 5, wherein the light shutter further includes a filling layer which is disposed on the lower substrate and is disposed so as to enclose the plurality of shutter structures, and
wherein a refractive index of the filling layer is higher than a refractive index of the plurality of transparent particles.

9. The display device of claim 1, wherein the plurality of color filters are disposed to form a plurality of columns and a plurality of rows, and
wherein the plurality of shutter structures are disposed so as to overlap some of the plurality of color filters.

10. The display device of claim 9, wherein each of the plurality of shutter structures is disposed to be spaced apart from each other with an area of one color filter, among the plurality of color filters, therebetween.

11. The display device of claim 1, further comprising:
a first polarizer disposed between the display panel and the backlight unit; and
a second polarizer disposed on the display panel,
wherein the display panel further includes:
a first substrate;
liquid crystal disposed between the first substrate and the plurality of color filters and between the first substrate and the black matrix; and
a second substrate on the plurality of color filters and the black matrix.

12. The display device of claim 11, wherein the light shutter is disposed between the second substrate and the second polarizer.

13. The display device of claim 11, wherein the light shutter is disposed between the liquid crystal and the plurality of color filters and between the liquid crystal and the black matrix.

14. The display device of claim 11, wherein the light shutter is disposed between the first substrate and the first polarizer.

15. The display device of claim 11, wherein the light shutter is disposed between the first polarizer and the backlight unit.
